(19) United States
(12) Patent Application Publication
(10) Pub. No.: US 2014/0033024 A1
(43) Pub. Date: Jan. 30, 2014

(54) MULTI-ITEM PAGE LAYOUT MODIFICATIONS BY GAP EDITING

(71) Applicants: Richard A. Gartland, Bothell, WA (US); Michael A. Ninness, Bellevue, WA (US); Amanda McCoy Bast, Seattle, WA (US)

(72) Inventors: Richard A. Gartland, Bothell, WA (US); Michael A. Ninness, Bellevue, WA (US); Amanda McCoy Bast, Seattle, WA (US)

(73) Assignee: Adobe Systems Incorporated, San Jose, CA (US)

(21) Appl. No.: 12/419,982

(22) Filed: Apr. 7, 2009

(51) Int. Cl. G06F 17/00

(52) U.S. Cl. 715/244; 715/862

(57) ABSTRACT

A method includes executing instructions on a computer system to determine position information of one or more page items on a page. The method further includes executing instructions on the computer system to determine position information of one or more gaps associated with the one or more page items on the page. A gap of the one or more gaps may be adjusted by repositioning one or more of its boundaries using a gap tool.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2008, ADOBE SYSTEMS INCORPORATED. All Rights Reserved.

### TECHNICAL FIELD

The present application relates generally to the technical field of data processing. An example embodiment relates to manipulating items displayed in a document by manipulating the spaces or gaps between the items in the document.

### BACKGROUND

A page layout generally includes multiple page items (sometimes referred to as “pageitems” or “page objects” or simply “objects”). A page item may include texts, images or both. To change the position of a page item, the page item may be selected and dragged to its new position. A group of page items may be related to one another based on their positions on a page. To change the positions of the group of page items while still maintaining their positions relative to one another, the group of page items may be selected and moved all at once.

### BRIEF DESCRIPTION OF DRAWINGS

Some embodiments are illustrated by way of example and not limitation in the figures of the accompanying drawings in which:

FIG. 1A illustrates an example of page items, in accordance with some example embodiments.

FIG. 1B illustrates an example of resizing page items, in accordance with some example embodiments.

FIGS. 1C and 1D illustrate examples of adjusted page items, in accordance with some example embodiments.

FIGS. 2A and 2B illustrate examples of gaps in between page items, in accordance with some example embodiments.

FIGS. 3A and 3B illustrate examples of operations associated with gaps, in accordance with some example embodiments.

FIGS. 3C and 3D illustrate additional examples of operations associated with gaps, in accordance with some example embodiments.

FIGS. 3E and 3F illustrate adjustment of content, in accordance with some example embodiments.

FIG. 4A illustrates examples of a page with multiple page items and gaps, in accordance with some example embodiments.

FIG. 4B illustrates an example of a gap that is highlighted, in accordance with some example embodiments.

FIG. 5 illustrates an example of page items as related to margins, in accordance with some example embodiments.

FIG. 6A illustrates an example of page items with coordinate information, in accordance with some example embodiments.

FIG. 6B illustrates an example of determining coordinate values of a gap, in accordance with some example embodiments.

FIG. 6C illustrates example tables that may be used to store position values for page items and gaps, in accordance with some example embodiments.

FIGS. 6D-6E illustrate example tables that may be used to store position information for page items and gaps, in accordance with some example embodiments.

FIG. 7A illustrates an example of a layer of page items, in accordance with some example embodiments.

FIG. 7B illustrates an example of a page with multiple layers of page items and gaps, in accordance with some example embodiments.

FIG. 7C illustrates an example table that may be used to store position information for gaps in multiple layers, in accordance with some example embodiments.

FIG. 8 illustrates an example of a tool palette, in accordance with some example embodiments.

FIG. 9 is a block diagram that illustrates example functional modules associated with the gap operations, in accordance with some example embodiments.

FIG. 10 is an example flow diagram illustrating a method that may be used to manipulate a gap, in accordance with some example embodiments.

FIG. 11 is an example flow diagram illustrating a method that may be used to present gap information, in accordance with some example embodiments.

FIG. 12 is an example flow diagram illustrating a method that may be used to determine position information of a gap, in accordance with some example embodiments.

FIG. 13 is a block diagram of machine in the example form of a computer system within which instructions, for causing the machine to perform any one or more of the methodologies discussed herein, may be executed, in accordance with some example embodiments.

### DETAILED DESCRIPTION

For some example embodiments, methods and systems to manipulate white space or gaps among page items are disclosed. In the following description, for purposes of explanation, numerous specific details are set forth in order to provide a thorough understanding of some example embodiments. It will be evident, however, to one skilled in the art that the present invention may be practiced without these specific details.

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter. Some portions of the detailed description which follow are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

### Page Item Operations

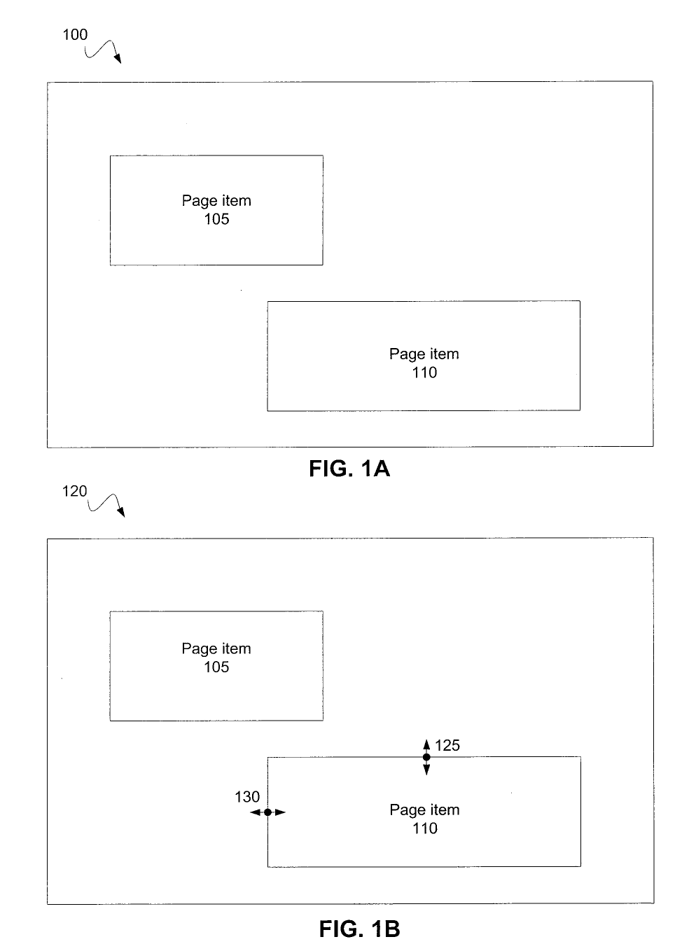

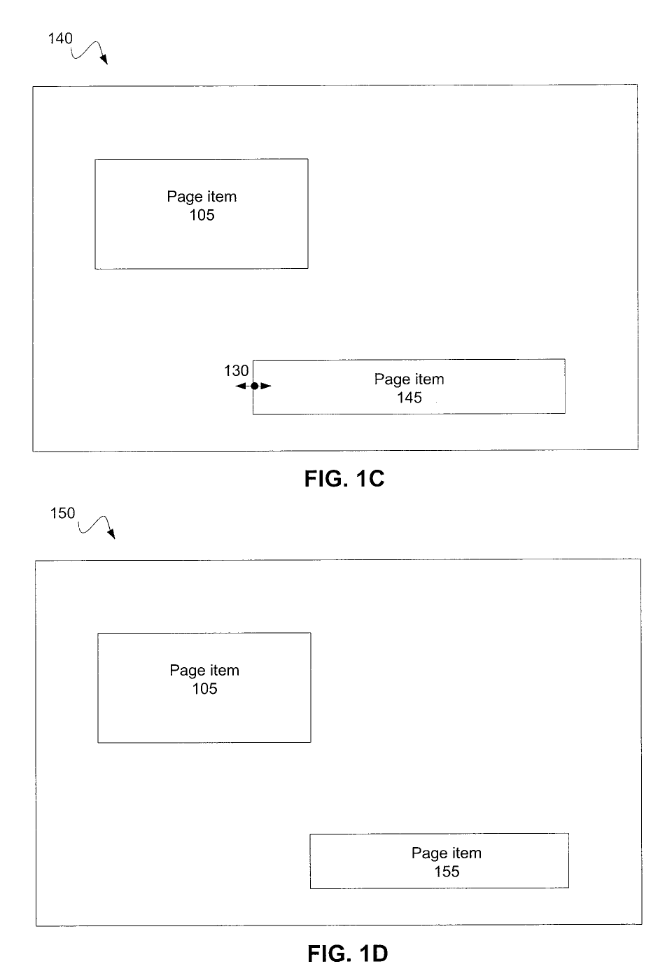

FIG. 1A illustrates an example of page items, in accordance with some example embodiments. Page 100 includes page item 105 and page item 110. Each of the page items 105 and 110 may be associated with an image, texts or various types of multimedia information. Although not shown, other page items may also be included in the page 100. The page 100 may be created using a design application. One example of such a design application is Adobe InDesign® CS4 from Adobe Systems Incorporated of San Jose, Calif. The design application may execute instructions to include a tool palette. The tool palette may include multiple types of tools including, for example, spray paint tool, select tool, shape tool, text box tool, erase tool, etc. For example, the page item 105 or 110 may be created using a shape tool to draw a geometry shape such as a rectangular shape. In the situations when the page item 105 or 110 is a text-based page item, the text box tool may be used.

A page item may be manipulated by using one or more tools from the tool palette. For example, a move tool may be used to move or drag the page item from one position to another position on a page. As another example, a resize tool may be used to resize the shape of a page item. Other tools that add graphics, texts, etc. to the page item may also be used. FIG. 1B illustrates an example of resizing page items, in accordance with some example embodiments. The page item 110 may be resized vertically by positioning a cursor associated with a pointing device (e.g., a computer mouse) at location 125. The page item 110 may also be resized horizontally by positioning the cursor at location 130. In the example, a line with double arrows is illustrated to show the possible directions of horizontal resizing or vertical resizing. FIGS. 1C and 1D illustrate examples of the original page item 110 resized vertically into page item 145 and subsequent resized horizontally into page item 155. Typically, a page item is first selected, and then the different operations may be applied based on the tools used. When a group of page items is to be manipulated, a region that includes the page items is first identified, and then the different operations may be applied.

One problem with the above approach is the complexity involving manipulating multiple page items when they cannot be selected as a group. For example, since there is no restriction on where a page item may be placed on a page, multiple page items of different sizes may be created and placed in any positions including partially and/or fully overlapping positions. As such, it is usually not possible to select a group of page items without including a page item that is not to be included in the group. The unwanted page item can then be tediously deselected from the group. Thus, when the page designer wants to manipulate certain page items, these page items may have to be manipulated individually. One example of operations that may require operations on the individual page items is the adjustment of space or gap in between a group of page items to maintain a certain alignment. This adjustment is typically performed on one side of the gap and then repeated on the other side of the gap one page item at a time (or one group of page items on one side at a time). This can be tedious and time consuming. As will be described, for some example embodiments, a gap tool may be used to resize a gap in fewer operations.

### Gaps and Gap Operations

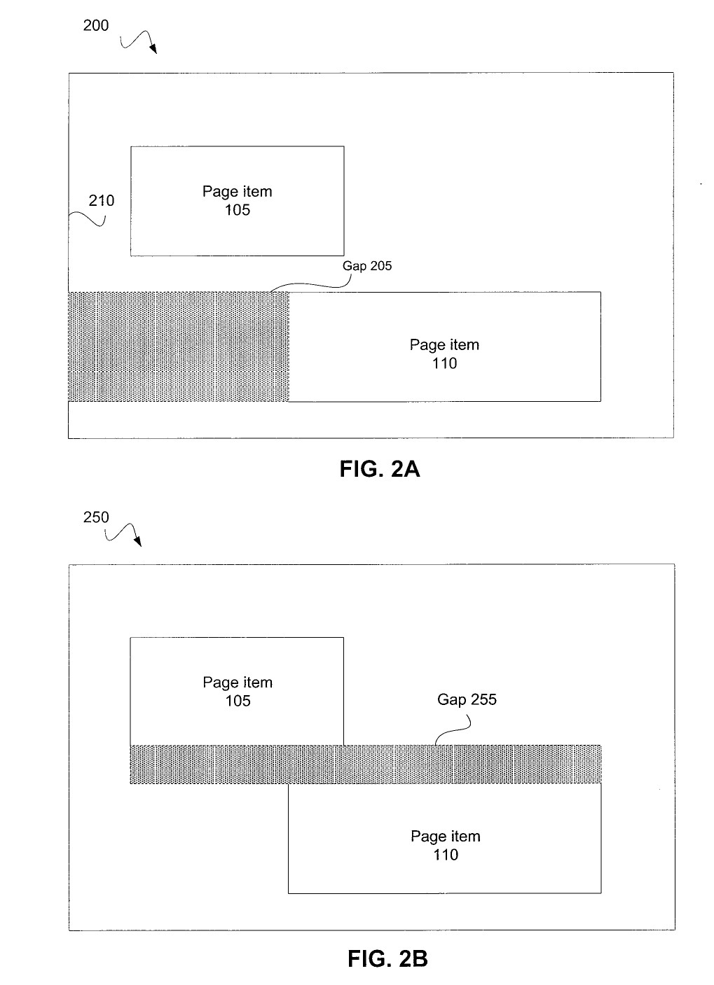

FIGS. 2A and 2B illustrate examples of gaps in between page items, in accordance with some example embodiments. The page items 105 and 110 illustrated in FIGS. 2A and 2B are similar to those illustrated in FIGS. 1A and 1B. In addition, FIG. 2A includes a gap 205 that exists between the page item 110 and a left edge 210 of the page 200. FIG. 2B includes a gap 255 that exists between the page item 105, the page item 110, a left edge of the page item 105 and a right edge of the page item 110. Both the gaps 205 and 255 are highlighted for illustration purposes. Although not shown, there is a gap between each of the page items 105 and 110 to each of the edges of the page 200 or 250. In general, a gap may exist between two edges. An edge can be that of a page item or an edge of a page.

For some example embodiments, a gap may be manipulated using a gap tool selected from the tool palette or using combination of one or more keys from a keyboard associated with a computer system. The computer system may execute instructions associated with a design application to provide the ability to manipulate the gap. The tool palette and the gap tool will be described in more details.

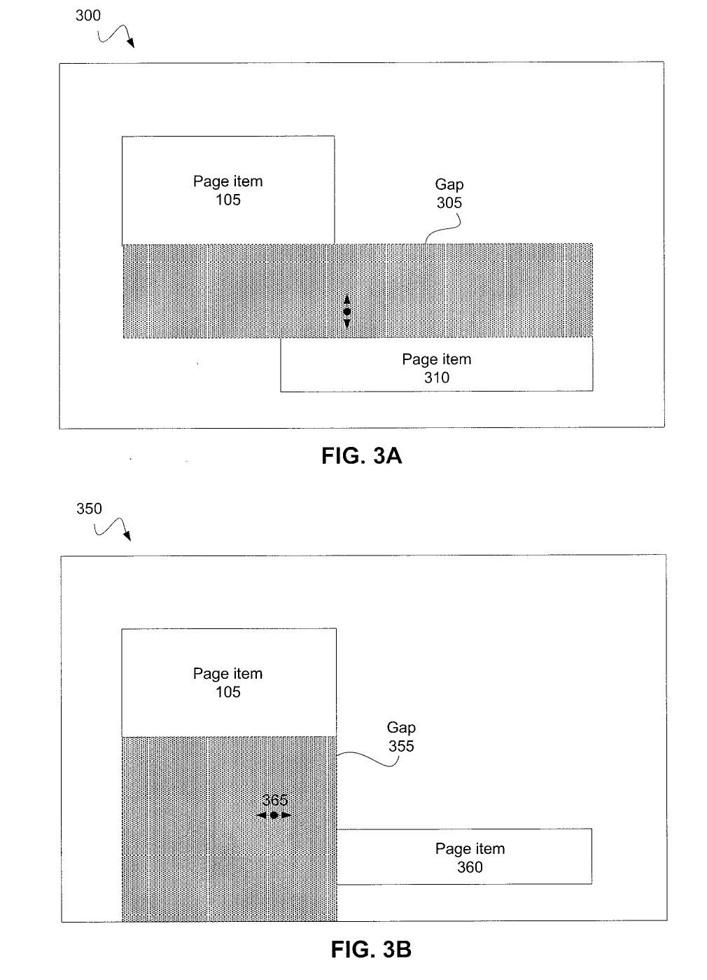

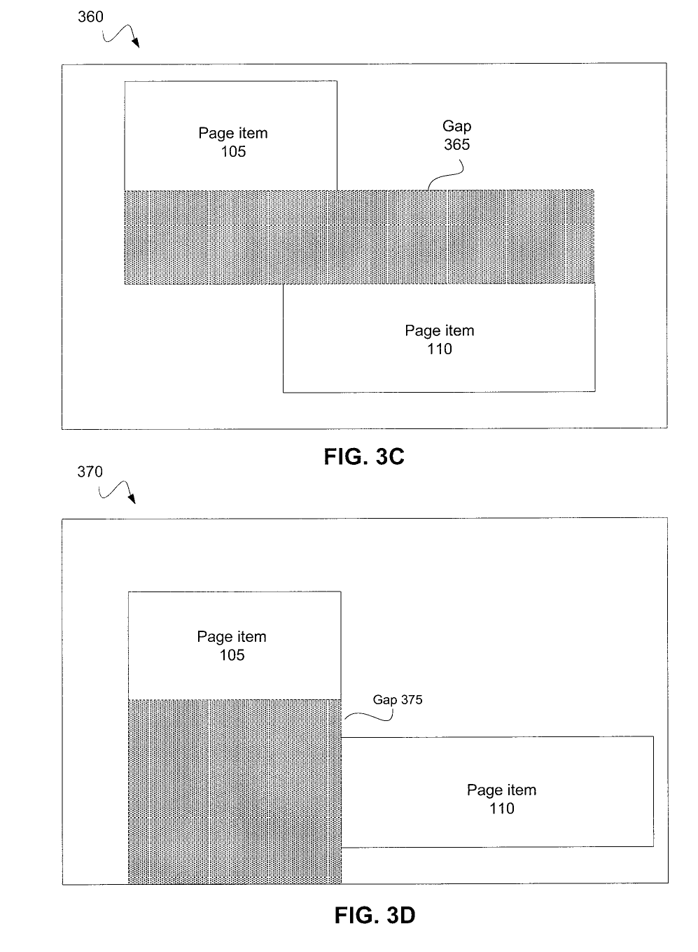

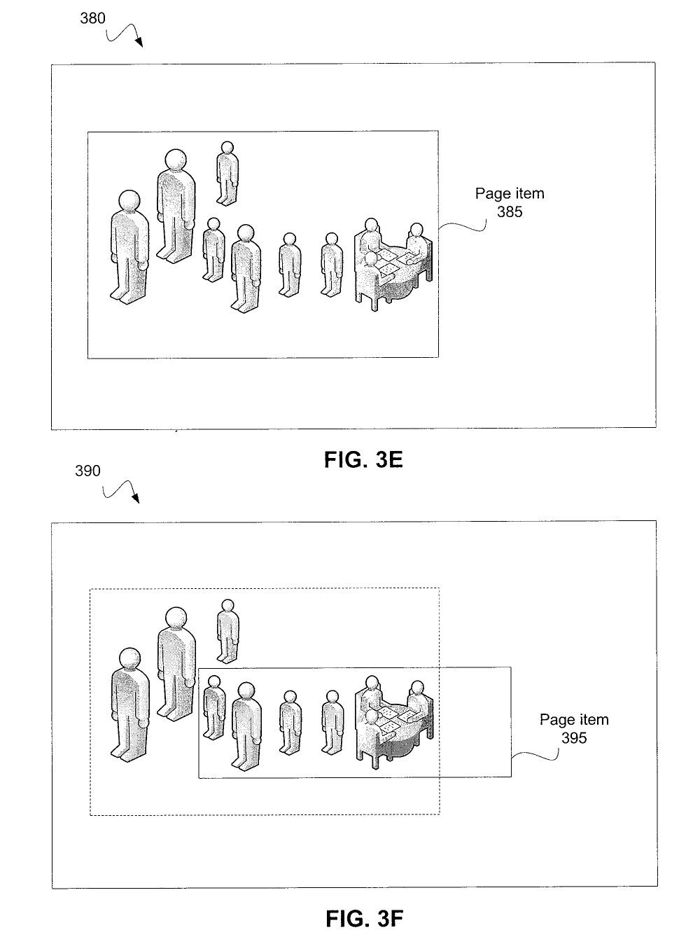

FIGS. 3A and 3B illustrate examples of operations associated with gaps, in accordance with some example embodiments. In these examples, the operations associated with the gaps may affect the sizes (or positions) of corresponding page items. As illustrated in FIG. 3A, gap 305 may be resized vertically by positioning a cursor associated with a pointing device. For some example embodiments, the gap may be moved as a whole unit. For example, placing a cursor of a pointing device within the gap may cause the gap to move in the direction of the cursor. It may be noted that while the gap 305 is being resized to become larger, the page item 310 is automatically resized to become a smaller page item 310. The size of the page item 310 is not based on any operations on the page item 310 but is based only on operations on the gap 305. Similarly, as illustrated in FIG. 3B, gap 355 may be resized horizontally by positioning a cursor associated with a pointing device at location 365. It may be noted that while the gap 355 is resized to become larger, the page item 310 is automatically resized to become a smaller page item 360.

FIGS. 3C and 3D illustrate additional examples of operations associated with gaps, in accordance with some example embodiments. In these examples, the operations associated with the gaps may affect the positions and not the sizes of the corresponding page items. As illustrated in FIG. 3C, gap 365 is resized vertically while the page item 110 is moved vertically to accommodate the larger gap. The size of the page item 110 remains the same. As illustrated in FIG. 3D, the gap 375 is resized horizontally while the page item 110 is moved horizontally to accommodate the larger gap. The size of the page item 110 remains the same. For some example embodiments, a combination of one or more keys on a keyboard may be used to indicate whether the gap operations cause the associated page items to be moved or to be resized. For example, a SHIFT key, an ALT key or a CTRL key may be held while the gap tool is used to distinguish between a gap move and a gap resize operation. It is possible to move the gap, thus resizing the page items, as if a user had used a resize tool by dragging on the edge (of the page item) that abuts the gap. In an example gap-move operation, the page items on one side of the gap become wider, while the page items on the opposite side of the gap become narrower—that is, the gap shifts position based on the change of the width of the page items. In an example gap-resize operation, the page items either both shrink or widen, depending on whether the operation is widening the gap or narrowing it. But you can also do the gap resize or move with a modifier that says simply to move the page items instead of resizing them.

FIGS. 3E and 3F illustrate adjustment of content, in accordance with some example embodiments. In FIG. 3E, page item 385 in page 380 includes an image in its original size. When the page item 385 is resized based on one or more gap resizing operations of associated gaps, the page item 385 becomes page item 395 in page 390. Since the page item 395 is smaller, the original image needs to be adjusted. For some example embodiments, the design application may execute instructions to enable the original image (or content) to be viewable, as illustrated in FIG. 3F. This may allow the page designer to move the original image to select a portion of the original image to be included in the page item 395.

For some example embodiments, the content of the adjusted page item may be automatically adjusted. The content may be cropped, stretched, shrunk, adjusted, etc. depending on the option selected by the page designer. For some example embodiments, when the content of the page item includes textual information (e.g., text boxes), the flow of the textual information (e.g., the paragraphs, the sentences) may be adjusted. For example, when the page item is adjusted to be narrower, the paragraphs may be longer with less number of words per line. Alignment adjustment may also occur for downstream textual information.

When the adjusted page item cannot accommodate the original information, only a portion of the original information may be presented. The remaining portions may be pushed to another frame of the page item. A frame as used in this context refers to a set of information related to the information currently presented in the page item. When the adjusted page item can accommodate more than the original information, information from other frames may also be presented along with the original information. For example, this may include removing one or more paragraphs from the adjusted page item if the adjusted page item is smaller than before. This may include adding one or more paragraphs into the adjusted page item if the adjusted page item is larger than before. For some example embodiments, blank spaces may be added to accommodate the larger size of the page item. The design application may execute instructions to provide the page designer options or attributes to set how the content is adjusted.

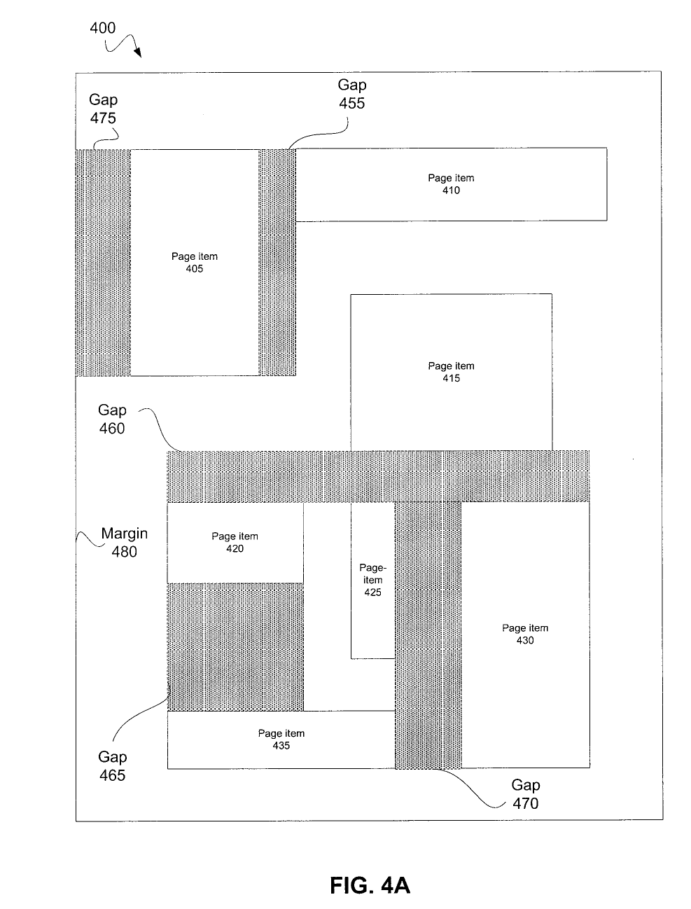

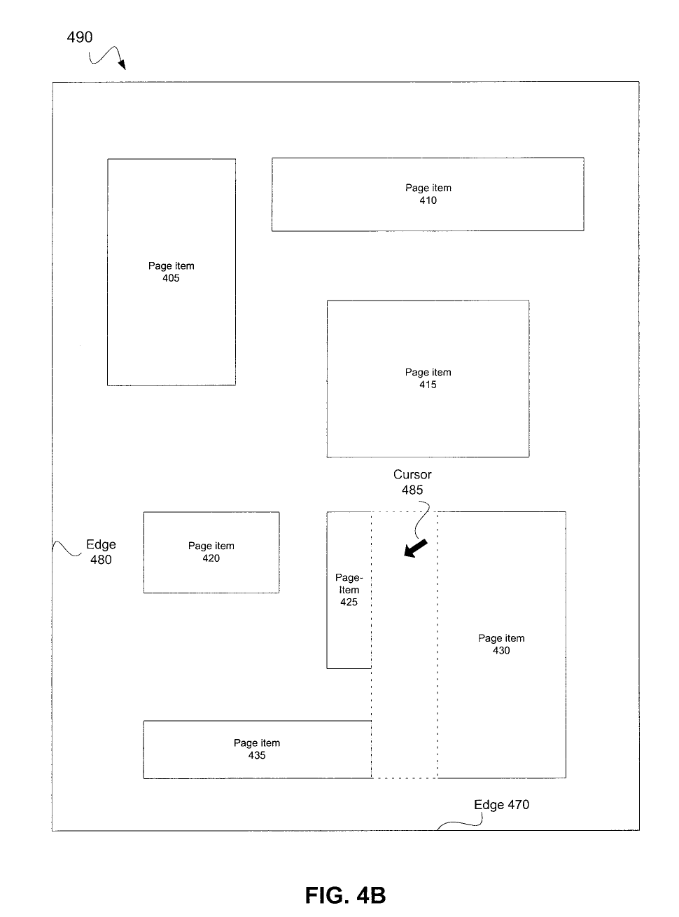

FIG. 4A illustrates examples of a page with multiple page items and gaps, in accordance with some example embodiments. Page 400 includes page items 405-435 and gaps 455-475. Although not shown, other gaps also exist on the page 400. It may be noted that the gap 455 extends horizontally from the page item 405 to the page item 410 and not to the page item 415. This is because the page item 410 is the next immediate page item that the gap 455 is adjacent to in the horizontal direction.

The gap 460 is associated with the page items 415, 420, 425 and 430. Traditionally, when the three page items 420-430 need to be resized so that they are equally aligned and further apart from the page item 415, each of the three page items 420-430 need to be manipulated individually. Tedious alignment issues may need to be dealt with by the page designer. The gap tool as described in some example embodiments provides the page designer a better technique to quickly perform the same operations. For example, the page designer may only need to resize the gap 460 vertically to affect page items 420-430 simultaneously. As another example, when the page designer adjusts (e.g., resize or move) the gap 470 horizontally, both the page items 430 and 435 may also be adjusted simultaneously in a way that corresponds to the adjustment of the gap 470.

For some example embodiments, when there are multiple page items aligned with a boundary of a gap, the design application may execute instructions to enable the page designer to select the number of page items that is affected by the gap operations. For example, the page designer may specify that only the page items 420 and 425 are affected when adjusting the size of the gap 460. For some example embodiments, a toggle scheme may be used to determine the page items that are affected by the gap operation. The toggle scheme may affect a full set of page items on the gap or only the two page items positioned across or opposite from each other and aligned with a position of the cursor. For example, when a SHIFT key is held down, then only the two opposite page items are affected by the gap operation.

For some example embodiments, a gap may be identified as existing between two page items even when a third page item extends, or intrudes, into the gap. For example, in FIG. 4A a vertical gap (not shown) may be identified as existing between page item 405 and page item 415, where the right edge of page item 405 forms the left boundary or edge of the gap, and the left edge of page item 415 forms the right boundary or edge of the gap. In this example, the top edge of page item 405 would form the top boundary or edge of the gap, while the bottom edge of page item 415 would form the lower or bottom boundary of the gap. In this example, the left portion of page item 410 is shown to extend, or intrude, into the gap. In some embodiments, the presence of an intruding page item, such as page item 410 in FIG. 4A, does not preclude the existence of a gap.

In some embodiments, an intruding page item may prevent a gap from being extended in one direction to include more than two page items. For instance, continuing with the example presented above, in FIG. 4A, the left edge of page item 425 is aligned with the left edge of page item 415. In such a scenario, the vertical gap formed between page items 405 and 415 may be extended vertically, such that the bottom, or lower edge, of the gap would align with the bottom of page item 425. However, in this example, page item 420 would be an intruding page item, if the gap was extended vertically to align with the lower edge of page item 425. In some embodiments, the presence of an intruding page item, such as page item 420 in this example, prevents a gap from being extended in one direction to include page items that share a boundary with one of the two page items forming the gap.

In various embodiments, the gap tool can be configured to handle an intruding page item in one of several ways when performing gap operations. For instance, in some embodiments, the intruding page item in the gap may be ignored for purposes of resizing or moving a gap, or page item. Alternatively, the intruding page item may be moved or resized during a gap operation in much the same way that one of the page items forming a boundary of a gap may be moved or resized.

For some example embodiments, the design application may execute instructions to enable the page designer to identify and manipulate multiple gaps simultaneously. For example, referring to FIG. 4B, the page designer may move the gap 485 and resize the page items 425 and 430 simultaneously in the vertical direction. Although not shown, it may be noted that there is a gap between the page item 415 and the bottom edge of the page 490. For some example embodiments, the vertical and horizontal resizing of this gap may affect the positions of the page items 415, 425, 430 and 435.

When two page items are positioned immediately adjacent to one another (or abutting), there is no gap. Alternatively, it may be viewed that the gap in those situations has zero width and zero height, and the gap tool may be used to manipulate such a gap. For some example embodiments, a page with no page item (e.g., a blank page) is considered to have zero gaps.

### Gap Highlight

For some example embodiments, when a gap tool is selected, a gap is highlighted whenever a cursor associated with a positioning device is positioned within the gap. The highlighted areas of the gap may include the boundaries of the gap. For discussion purposes, each rectangular gap may be considered to include four boundaries including a top, a bottom, a left and a right boundary. Each of the page item may be considered to include four edges including a top, a bottom, a left and a right edge. The highlighted areas of the gap may also include gap crossways (e.g., two diagonal lines connecting opposite corners of the gap). The gap may be highlighted even though no operation is performed. This may enable a page designer to view the possible gap options before deciding whether to apply any gap operations. The highlighted areas of the gap may include areas that enable the gap to be selected and manipulated. Other highlighting techniques may also be used. For example, arrows may be used at each end of a gap to show the extent of the gap. A gap is highlighted based on tracking a position of a cursor. This provides a useful feedback as the cursor is moved around the page.

For some example embodiments, the entire content area of the gap may be highlighted. For example, a color or a pattern may be used for highlighting. FIG. 4B illustrates an example of a gap that is highlighted, in accordance with some example embodiments. The page items and gaps on page 490 of FIG. 4B are similar to those on page 400 of FIG. 4A with the only difference in the gap 470 being highlighted (illustrated as dashed line boundaries) when the cursor 485 associated with a pointing device is positioned within the gap 470.

### Margin

For some example embodiments, a gap extends to a margin of a page when there is no other page item in between the gap and the margin. Referring to the example in FIG. 4A, the gap 465 extends horizontally from the page item 425 to the margin 480 of the page 400. The same gap 465 extends vertically from the page item 420 to the page item 435. There may be top, bottom, left and right margins. Depending on how wide a margin is defined, the margin 480 may or may not be the actual left edge of the page 400.

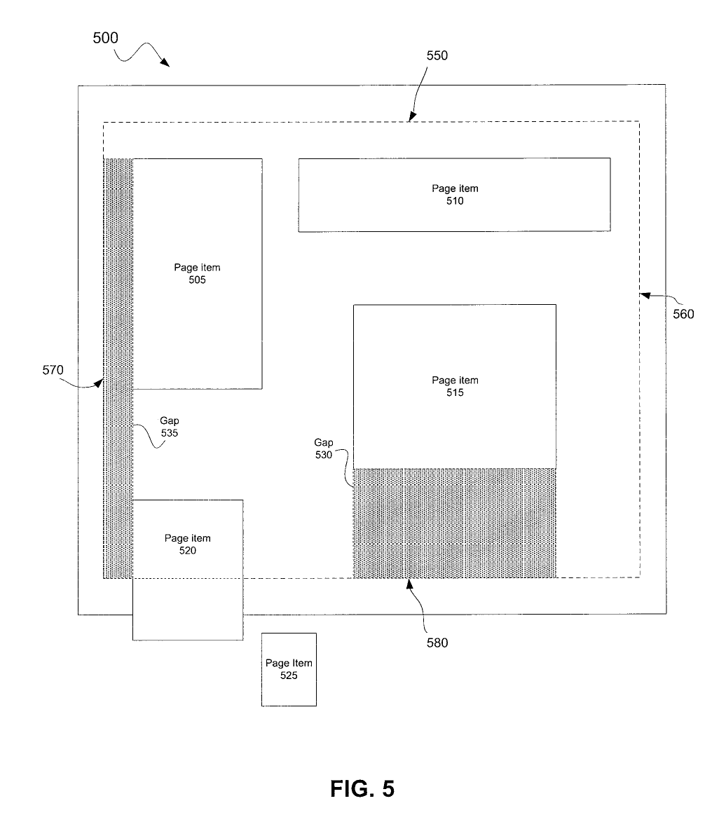

FIG. 5 illustrates an example of page items as related to margins, in accordance with some example embodiments. Page 500 includes a top margin 550, right margin 560, left margin 570 and bottom margin 580. The margins 550-580 are illustrated in the example using dashed lines. The gap 535 extends from the left margin 570 to the page item 505 and the page item 520. The gap 530 extends horizontally from the left edge to the right edge of page item 515, and vertically from the lower edge of page item 515 to the bottom margin 580. For some example embodiments, only portions of a page item that is within the margins of a page are recognized by the gap tool of the design application for the purposes of determining the associated gaps. Referring to FIG. 5, page item 520 partially extends beyond the bottom margin 580, and therefore the portion that is outside of the bottom margin 580 is not recognized by the gap tool. Similarly, page item 525 is positioned completely beyond the margins of the page 500, and therefore is not at all recognized by the gap tool.

It may be noted that, in some example embodiments, the margins of a page are ignored and the edges of the page are used to determine whether a page item is recognized by the gap tool.

### Page Item Coordinate Values

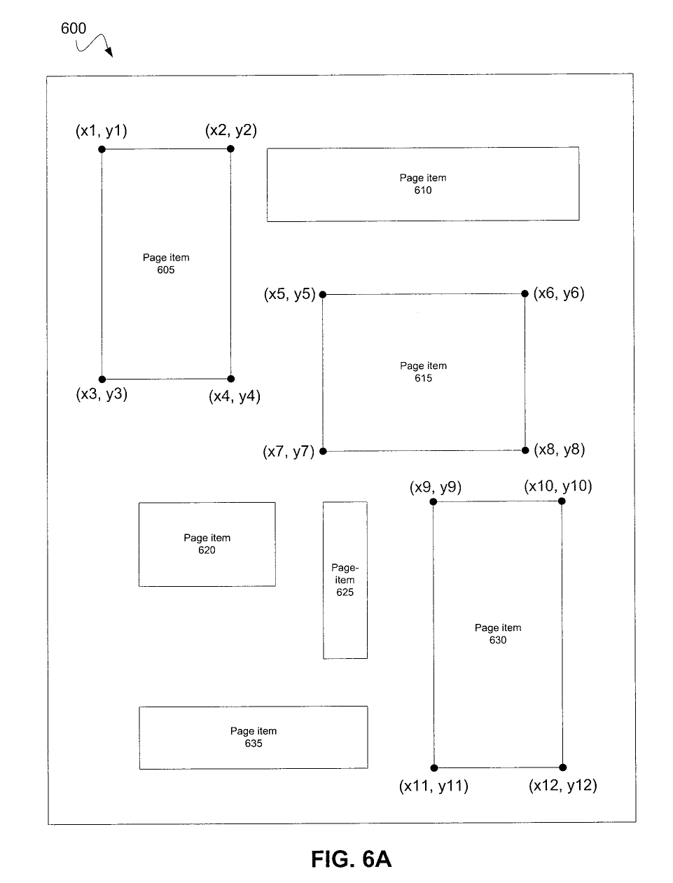

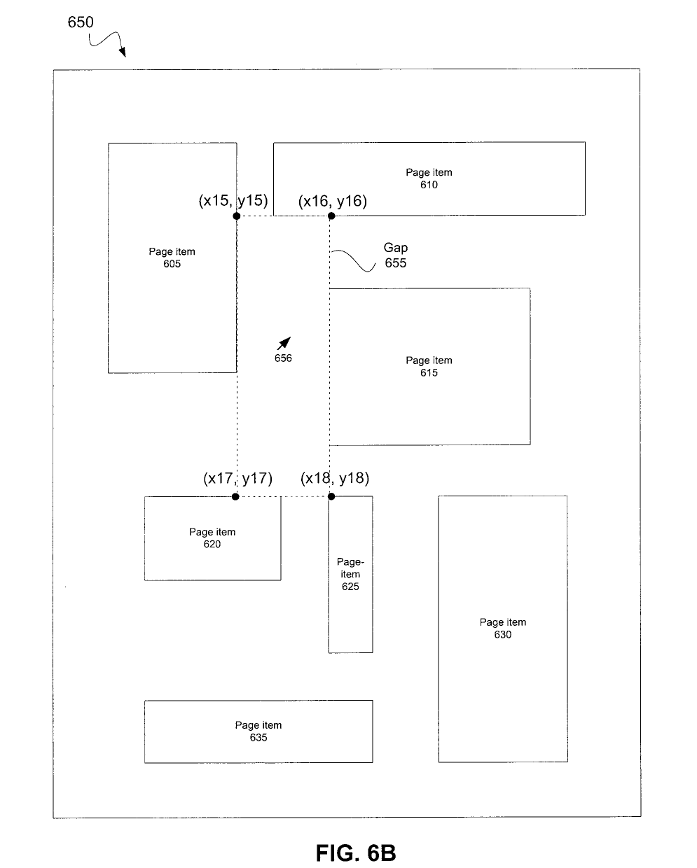

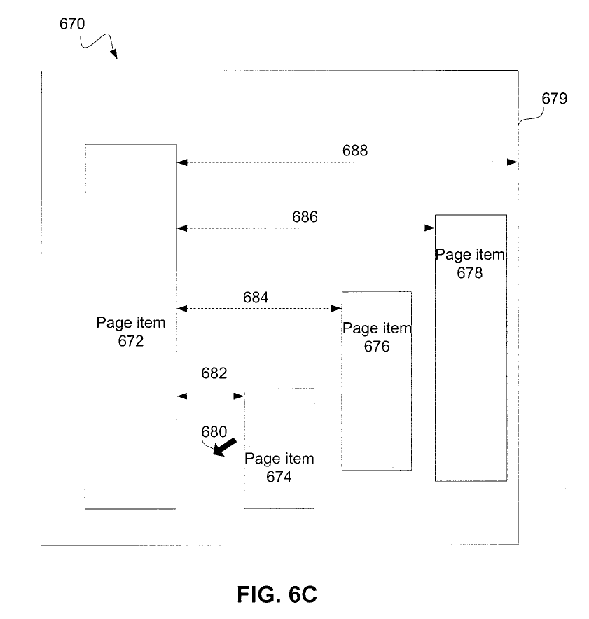

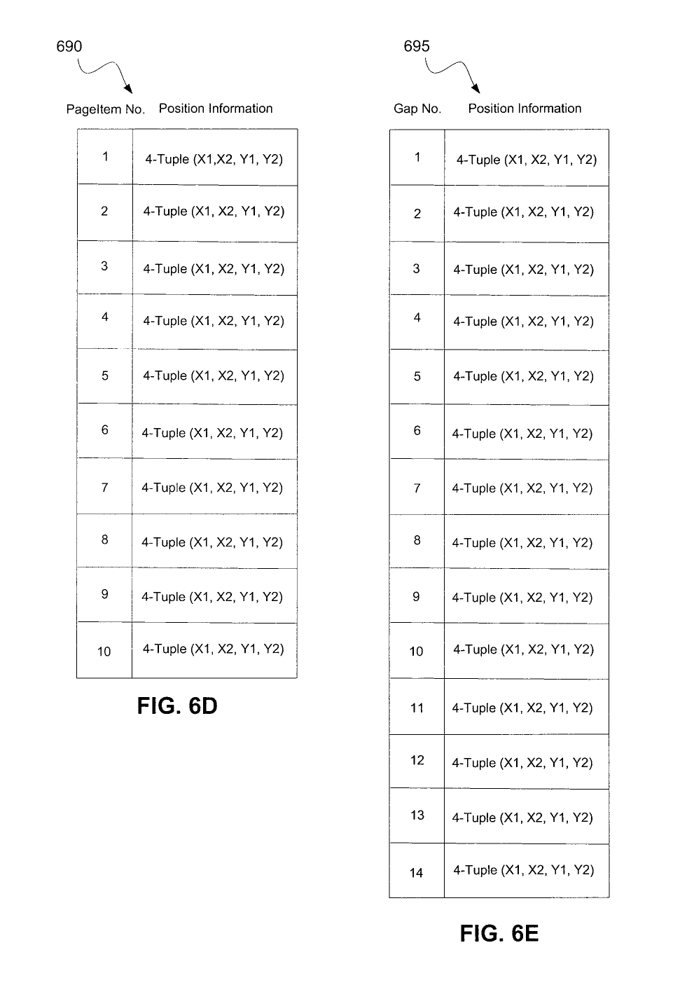

FIG. 6A illustrates an example of page items with coordinate information, in accordance with some example embodiments. For some example embodiments, each of the page items that is within the margins of a page is associated with a set of coordinate values, each coordinate value corresponding to one corner of the page item. For example, when the page item is rectangular in shape, there are four coordinate values. The coordinate values include a horizontal value and a vertical value. The horizontal value may correspond to a horizontal position on the page. The vertical value may correspond to a vertical position on the page. The four coordinate values of a page item forms a rectangular bounding box. Referring to FIG. 6A, the page item 605 includes four coordinate values (x2, y2), (x2, y2), (x3, y3) and (x4, y4). Note that, in this example, x1=x3, and y1=y2, etc. The page item 615 includes four coordinate values (x5, y5), (x6, y6), (x7, y7) and (x8, y8). Similarly, the page item 630 includes four coordinate values (x9, y9), (x10, y10), (x11, y11) and (x12, y12). Although not shown, similar coordinate values also exist for the page items 610, 620, 625, 630 and 635.

It may be noted that, although the examples include coordinate values that represent a two-dimensional page item, other coordinate values for more than two dimensions may also be used. For example, when applying the techniques described herein with a three-dimensional page item, the gap tool may also be used to manipulate a three-dimensional gap. It may also be noted that, although the page items and the gaps are described based on rectangular shapes, other geometrical shapes (e.g., oval, free-form, etc.) may also be used.

In other embodiments, the coordinate values for a page item may be specified as a 4-tuple, where each component of the 4-tuple represents an X or Y coordinate value corresponding with an edge of the rectangular shaped page item. For instance, in the example presented in FIG. 6A, page item 605 may be represented as the 4-tuple (x1, x2, y1, y3).

### Gap Coordinate Values

FIG. 6B illustrates an example of determining coordinate values of a gap, in accordance with some example embodiments. The page items and gaps on page 650 of FIG. 6B are similar to those on page 600 of FIG. 6A with the only difference in the gap 655 being associated with coordinate values (x15, y15), (x16, y16), (x17, y17) and (x18, y18) based on the position of the four corners of the gap 655. For some example embodiments, the design application may execute instructions to determine the coordinate values for all of the page items found on a page. The coordinate values may then be stored and used to determine the positions of the gaps on the page. The coordinate values of a gap may be determined by comparing the coordinate values of two adjacent page items along the horizontal axis and along the vertical axis. The design application may also execute instructions to determine the current location of the cursor associated with a pointing device. This may enable the design application to determine which of the gaps to be highlighted. As described above, when there is no adjacent page item, one or more of the edges may be used to determine the position of the gap. Referring to FIG. 6B, in some embodiments, when the cursor is at position 656, the highlighted gap would overlap the right edge of the page item 605, the left edge of the page item 615 along with the left edge of the page item 625 since the page item 625 shares the same edge of the gap with the page item 615.

In some embodiments, the gap coordinate values may be specified as a 4-tuple, in the same manner as page items as described above.

### Gap Ordering

FIG. 6C illustrates an example of multiple gaps determined based on a cursor position, in accordance with some example embodiments. Page 670 includes four page items 672-678. Cursor 680 is positioned between the page items 672 and 674. A gap that exists between the page items 672 and 674 has a gap width 682 (illustrated by the dash double-ended arrows). It may be noted that the cursor 680 is also positioned between the page items 672 and 676. A gap that exists between the page items 672 and 676 has a gap width 684. Further, the cursor 680 is also positioned in, between the page items 672 and 678. A gap that exists between the page items 672 and 678 has a gap width 686. Finally, the cursor 680 is also positioned in between the page item 672 and the right edge 679 of the page 670. A gap that exists between the page item 672 and right edge 679 has a gap width 688. Although not shown, one or more gap height may also be determined.

For some example embodiments, based on a position of the cursor, one or more gaps may be determined and presented. For example, the one or more gaps may be displayed as feedback to the page designer in response to the page designer positioning the cursor at a certain position on the page. For some example embodiments, the number of gaps may be presented as a list. The list may be ordered according to a certain criteria. One example may be based on the gap width. For example, the smallest or narrowest gap on the list may be presented first.

The number of gaps may be determined from the current position of the cursor toward the right edge of a page. Alternatively, the number gaps may be determined from the current position of the cursor toward the left edge of the page. For some example embodiments, all gaps toward the left edge and toward the right edge from the cursor position may be determined. The page designer may be provided an option to display gaps to the left or to the right of the position of the cursor.

For some example embodiments, the smallest gap (e.g., in gap width, gap height, or both) is presented as a default. The remaining gaps may be presented when one or more keys on the keyboard are selected. Alternatively, information about all of the gaps determined from the current position of the cursor is presented as a default. When one or more keys on the keyboard is selected (e.g., holding the SHIFT key), the smallest gap is presented.

For some example embodiments, a toggle tool may be used to enable skipping or cycling through the gaps in the list of gaps so as to select a desired gap.

### Data Structure

FIGS. 6D-6E illustrate example tables that may be used to store position information for page items and gaps, in accordance with some example embodiments. Page item table 690 in FIG. 6D may be used to store position values for the page items on a page. Gap table 695 in FIG. 6E may be used to store position values for the gaps on the page. In the examples presented in FIGS. 6D and 6E, 4-tuples are used to represent the lateral edges of the rectangular shaped page items and gap items. However, in alternative embodiments, four separate coordinate values might be used to represent the four corners of a rectangular shaped page item or gap, as described above. Each 4-tuple for each of the page items and for each of the gaps may be different from one another. When two page items are aligned horizontally, some of their Y-axis values may be similar. Similarly, when two page items are aligned vertically, some of their X-axis values may be similar. The page item table 690 and the gap table 695 may be implemented using a storage device such as, for example, a hard disk, random access memory (RAM), etc. For some example embodiments, the design application may execute instructions to generate the position values for the page items and for the gaps in a page whenever the page is opened. As the gaps are manipulated, the design application may execute instructions to dynamically update the page item table 690 and/or the gap table 695 to reflect any changes caused by the gap operations. For some example embodiments, only the data in the page item table 690 is stored in a persistent storage device when the page is closed. The data in the gap table 695 may be automatically created whenever the page is opened. Alternatively, the data in the gap table 695 is created the first time the gap tool is used after the page is opened. This may be useful since the page designer may not need to use the gap tool at all for certain pages.

It is possible that the number of gaps on a page is more than the number of page items. This is illustrated as an example in the page item table 690 with 10 page items and the gap table 695 with 14 gaps. It may be noted when a new page item is added to a page and in between two existing page items, the gaps between the two existing page items may remain the same. However, the new page item causes more gaps to exist horizontally and vertically (including gaps between the page item and the edges of the page), depending on how the new page item is added.

### Layers

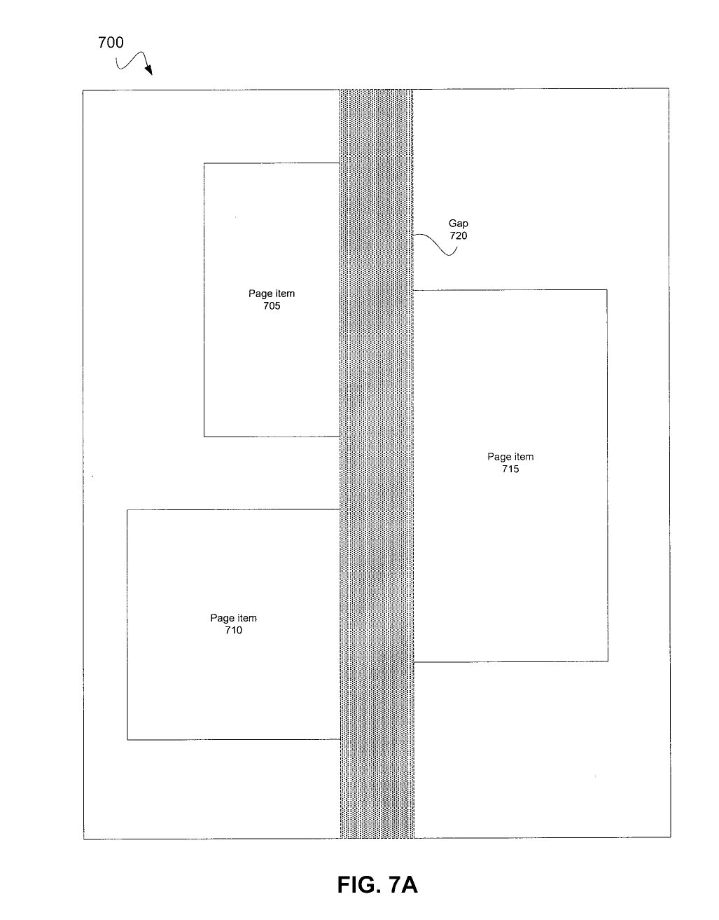

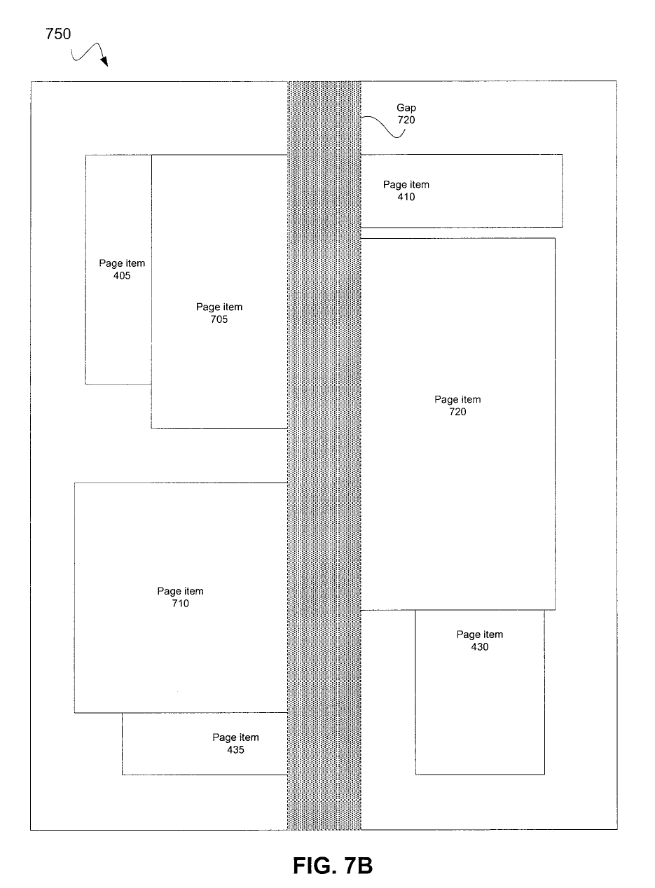

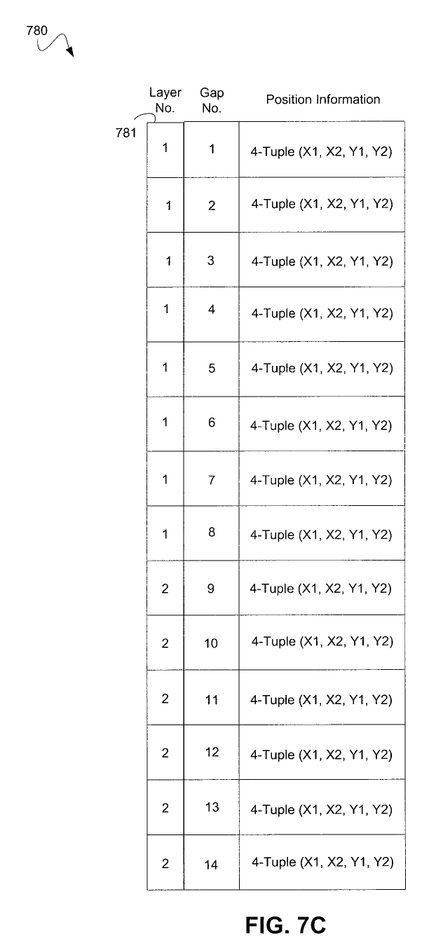

FIG. 7A illustrates an example of a layer of page items, in accordance with some example embodiments. For some example embodiments, a page may include one or more layers of page items and gaps. For some example embodiments, a layer may include one or more page items and one or more gaps. Page 700 includes three page items 705-715 and one gap 720. Although not shown, other gaps also exist on the page 700. The page items 705-715 and the gap 720 may belong to the same layer and may be copied and pasted or moved on top of another layer on a target page. This operation creates multiple layers of page items and gaps on the target page.

FIG. 7B illustrates an example of a page with multiple layers of page items and gaps, in accordance with some example embodiments. Page 750 of FIG. 7B is created by overlapping the page items and gaps from the page 700 as one layer on top of the page items and gaps of the page 400 of FIG. 4A as another layer.

For some example embodiments, the gap tool may be used to manipulate a gap based on the layer that the gap is associated with. For example, even though a lower layer may include a page item that is immediately adjacent to a page item on a higher layer, the gap tool will ignore the page item in the lower layer as if it does not exist and will only consider other page items in the higher layer. Referring to FIG. 7B, when applying the gap tool to the gap 720, the gap tool may ignore the page items 405, 410, 430 and 435 because these page items belong to a different layer. The design application may provide one or more tools in the tool palette to move a page item from one layer to another layer. It should be noted that, as the page items and the gaps are manipulated, the design application may dynamically update the coordinate values of the page items and the gaps in the one or more layers. The design application may further provide one or more tools to enable a page designer to identify page items and gaps in a particular layer.

FIG. 7C illustrates an example table that may be used to store position information for gaps in multiple layers, in accordance with some example embodiments. Gap table 780 in FIG. 7C may be used to store position values for the gaps along with attribute information identifying a layer that a gap is associated with. For example, the gap table 780 includes a layer column 781 that stores values that correspond to a layer number. When the page designer desires to work with page items and gaps on a particular layer (e.g., layer one), the designer application will only allow the page designer to manipulate the gaps that exist on the layer one. The page items and gaps on the other layer (e.g., layer two) made be made invisible to the page designer by the designer application.

For some example embodiments, each new page item added to a page is associated with a layer. These layers may be formed in a bottom-up stack, with the newest page item toward the top of the stack. Each page item can be modifed based on its position in the stack (called the z-order, for the z axis). Each layer may be named and can be turned on or off for visibility and editability. Further, a layer may be locked causing the page item to be protected from any modification.

For some example embodiments, the gap tool ignores the z-order of the layers, other than skipping the page items on invisible layers and not affecting the position or size of the page items on a locked layer. Thus, the gap tool would compute a gap between two page items even if they are on separate named layers

### Tool Palette—Gap Tool

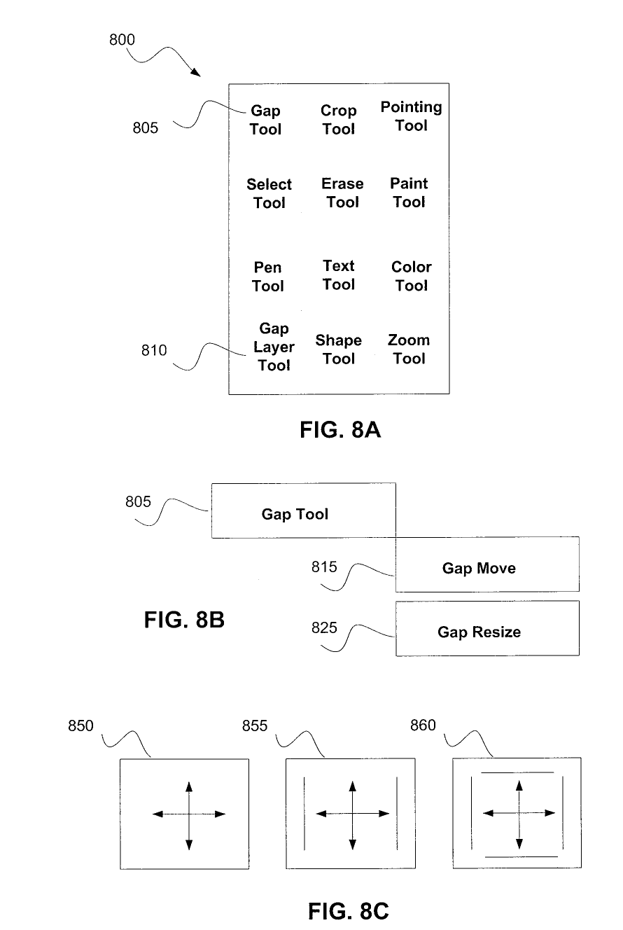

FIG. 8A illustrates an example of a tool palette, in accordance with some example embodiments. Tool palette 800 may be provided by the design application and may include a gap tool 805 to enable gap-related operations to be applied to one or more gaps identified on a page. Other tools in the tool palette 800 are illustrated merely as examples and do not affect the operations of the gap tool 805.

For some example embodiments, the design application may execute instructions to provide a gap layer selection function. The gap layer selection function may be activated by selecting gap layer tool 810 illustrated in FIG. 8A. The page designer may use this tool to manipulate gaps by layers. The gap layer tool 810 may be included in the tool palette 800.

FIG. 8B illustrates an example of a gap tool 805 that includes options for gap move 815 or gap resize 825, in accordance with some example embodiments. The gap move 815 and gap resize 825 options may be presented when the gap tool 805 is selected. It may be noted that although the gap tool 805 is illustrated as a text string, a graphical image or symbol may also be used to illustrate the gap tool 805. Examples of three variation of a gap tool image are illustrated in FIG. 8C as gap tools 850-855, each having two intersecting double arrow lines to represent the four possible directions to manipulate a gap.

### Functional Modules

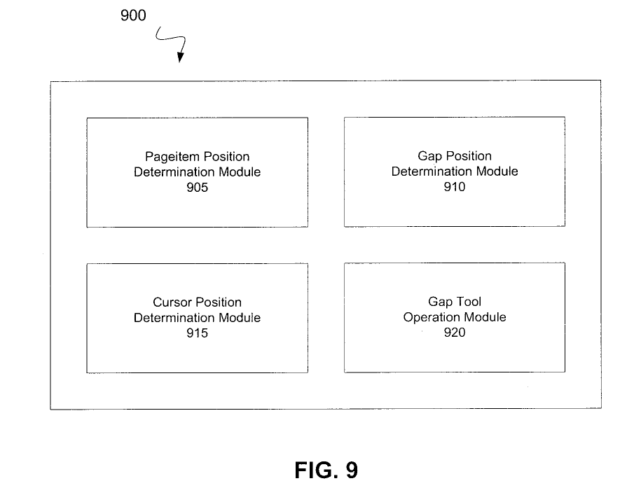

FIG. 9 is a block diagram that illustrates example functional modules associated with the gap operations, in accordance with some example embodiments. Page item position determination module 905 may include operations that identify page items on the page and determine coordinate information for these page items. As described above, the coordinate information may include coordinate values for four corners of the page items when the page items are rectangular in shape. Gap position determination module 910 may include operations that examine the page to identify gaps on the page and to determine coordinate information for these gaps. The gap position determination module 910 may use the coordinate information for the page items determined by the page item position determination module 905 in determining the position information for the gaps. The position information for the page items and for the gaps may be stored using the data structures illustrated in FIGS. 6D-E.

Cursor position determination module 915 may include operations to determine a current location of a cursor on the page. The cursor may be associated with a positioning or pointing device. The current position of the cursor may be used to determine whether the cursor is positioned within a gap, a page item, or neither. Gap tool operation module 920 may include operations that enable manipulation of a gap. This may include operations (e.g., move, resize) associated with a gap tool such as, for example, the gap tool 805. This may include operations associated with a gap layer such as, for example, the gap layer tool 810. This may include operations associated with displaying gap attributes (e.g., gap boundaries, gap list, gap ordering, etc.) whenever a current position of the cursor is found to be within a gap. Further, the gap tool operation module 920 may also include operations to move or adjust the sizes (and content when applicable) of the page items affected by the manipulation of the gap. It may be noted that, although the operations of the four modules 905-920 are described in separate modules, some of their operations may be combined into one or more common modules.

### Flow Diagram

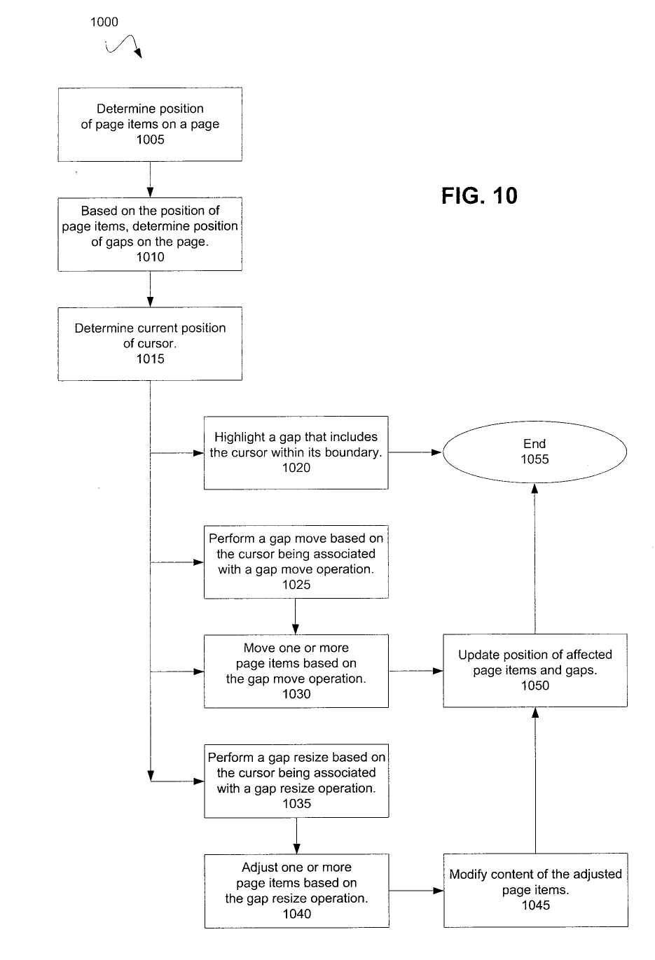

FIG. 10 is an example flow diagram illustrating a method that may be used to manipulate a gap, in accordance with some example embodiments. The method may be performed by a design application whose instructions are executed by at least one processor in a computer system. The flow may start at block 1005 where position information of page items on a page is determined. At block 1010, position information of gaps on the page is determined. At block 1015, position information of the cursor is determined.

From the block 1015, depending on the position of the cursor, different operations may be performed. For example, if it is determined that the cursor is positioned within a gap, information about the gap may be displayed. This may include highlighting the boundaries of the gap, as illustrated in block 1020. The flow may end at block 1055.

From the block 1015, if it is determined that a gap move operation is activated, the gap associated with the position of the cursor may be moved in a direction based on movement of the cursor, as illustrated in block 1025. At block 1030, one or more page items that are affected by the gap move operations performed in block 1025 are also moved in the same direction that the gap is moved. At block 1050, the position information of the gap and other affected gaps and/or page items are updated. The flow may end at block 1055.

From the block 1015, if it is determined that a gap resize operation is activated, the gap associated with the position of the cursor may be resized based on the movement and direction of the cursor, as illustrated in block 1035. At block 1040, one or more page items that are affected by the gap resize operations performed in block 1035 are also resized. At block 1045, the content of the resized page items may be adjusted. As described above, different techniques may be used to adjust the content. This may include, for example, cropping, zooming, etc. At block 1050, the position information of the gap and other affected gaps and/or page items are updated. The flow may end at block 1055.

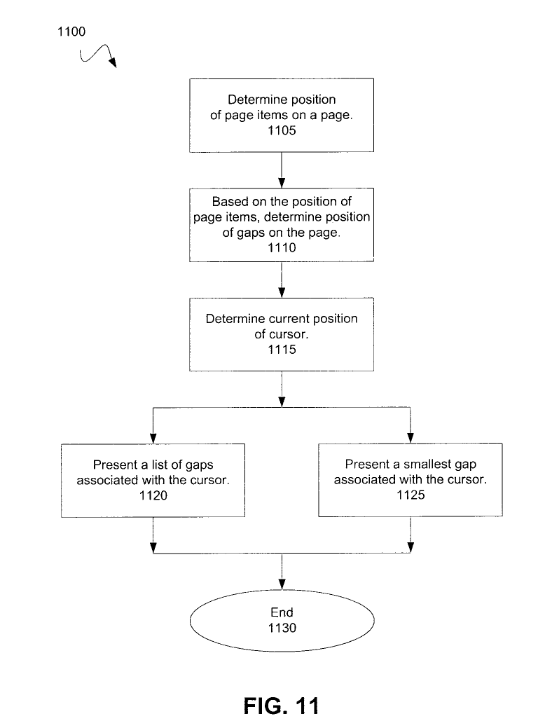

FIG. 11 is an example flow diagram illustrating a method that may be used to present gap information, in accordance with some example embodiments. The method may be performed by a design application whose instructions are executed by at least one processor in a computer system. The flow may start at block 1105. From block 1105-1115, position information of the page items, the gaps and the cursor are determined. Gap information may be presented based on the cursor position. For example, a list of all gaps associated with the cursor position may be presented, as illustrated in block 1120. The list of gaps may be presented based on a certain criteria, as described with FIG. 6C. The page designer may then which gap on the list to work with. Alternatively, only the gap information associated with a smallest gap is presented, as illustrated in block 1125. The flow may end at block 1130.

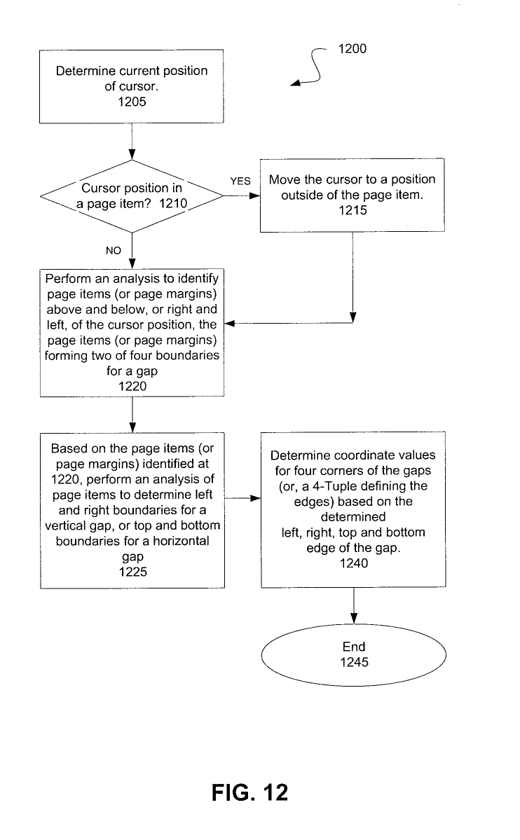

FIG. 12 is an example flow diagram illustrating a method that may be used to determine position information of a gap, in accordance with some example embodiments. In this example, it is assumed that the gap is rectangular in shape. The method may be performed by a design application whose instructions are executed by at least one processor in a computer system. The flow may start at block 1205 where position information of the cursor on a page is determined. At block 1210, it is determined whether the cursor is positioned within a page item. If it is, then the flow may continue to block 1215 where the cursor may be moved to a different position that is outside of the page item. From block 1215, the flow may continue to block 1220.

From block 1210, if the cursor is not positioned inside a page item, then the design application may attempt to identify two page items that together define two of the four boundaries for a rectangular shaped gap. For instance, at 1220, starting at the cursor position, an analysis is performed to identify page items (or page margins) above and below the cursor position, forming a horizontal gap, or to identify page items (or page margins) to the right and left of the cursor position, forming a vertical gap. For instance, a page item identified to the left of the cursor position may form the left edge of a vertical gap, whereas a page item identified to the right of the cursor position may form the right edge of a vertical gap.

Once the left-right or top-bottom edges of a possible gap are identified, at 1225, the page items (or page margins) associated with the identified edges are analyzed to determine the other boundaries. For instance, if at 1220, two page items below and above the cursor position are identified, then a horizontal gap can be defined if the left and right boundaries or edges can be identified. Accordingly, at 1225, the page items forming the top and bottom edges of the gap are analyzed to determine their dimensions, which will ultimately define the left and right edges of the horizontal gap. Similarly, if the page items identified in 1220 form a vertical gap, then those page items are analyzed at 1225 to determine the top and bottom edges of the gap.

At block 1240, the coordinate information of each of the four corners of the gap may be determined using the information determined from the operations associated with the blocks 1220-1225. Alternatively, a 4-Tuple defining the four edges of a gap may be determined. The flow may end at block 1245. It is possible that one of the boundaries of the gap may be associated with a margin of the page. This may occur when there is no page item between the current position of the cursor and the corresponding margin.

### Modules, Components and Logic

Certain embodiments are described herein as including logic or a number of components, modules, or mechanisms. A component may be a tangible unit capable of performing certain operations and is configured or arranged in a certain manner. In example embodiments, one or more computer systems (e.g., a standalone, client or server computer system) or one or more components of a computer system (e.g., a processor or a group of processors) may be configured by software (e.g., an application or application portion) as a “component” that operates to perform certain operations as described herein.

In various embodiments, a “component” may be implemented mechanically or electronically. For example, a component may comprise dedicated circuitry or logic that is permanently configured (e.g., within a special-purpose processor) to perform certain operations. A component may also comprise programmable logic or circuitry (e.g., as encompassed within a general-purpose processor or other programmable processor) that is temporarily configured by software to perform certain operations. It will be appreciated that the decision to implement a component mechanically, in dedicated and permanently configured circuitry, or in temporarily configured circuitry (e.g., configured by software) may be driven by cost and time considerations.

Accordingly, the term “component” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which components are temporarily configured (e.g., programmed), each of the components need not be configured or instantiated at any one instance in time. For example, where the components comprise a general-purpose processor configured using software, the general-purpose processor may be configured as respective different components at different times. Software may accordingly configure a processor, for example, to constitute a particular component at one instance of time and to constitute a different component at a different instance of time.

Components can provide information to, and receive information from, other components. Accordingly, the described components may be regarded as being communicatively coupled. Where multiple of such components exist contemporaneously, communications may be achieved through signal transmission (e.g., over appropriate circuits and buses) that connect the components. In embodiments in which multiple components are configured or instantiated at different times, communications between such components may be achieved, for example, through the storage and retrieval of information in memory structures to which the multiple components have access. For example, a one component may perform an operation, and store the output of that operation in a memory device to which it is communicatively coupled. A further component may then, at a later time, access the memory device to retrieve and process the stored output. Components may also initiate communications with input or output devices, and can operate on a resource (e.g., a collection of information).

The term “module”, as used herein, should be understood to refer more broadly to a tangible component or a software component, or any combination thereof. Accordingly, a module may be implemented in electronic circuitry, hardware, firmware, software or a combination thereof.

### Electronic, Apparatus and System

Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA (field programmable gate array) or an ASIC (application-specific integrated circuit).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination permanently and temporarily configured hardware may be a design choice. Below are set out hardware (e.g., machine) and software architectures that may be deployed, in various example embodiments.

### Example Machine Architecture and Machine-Readable Medium

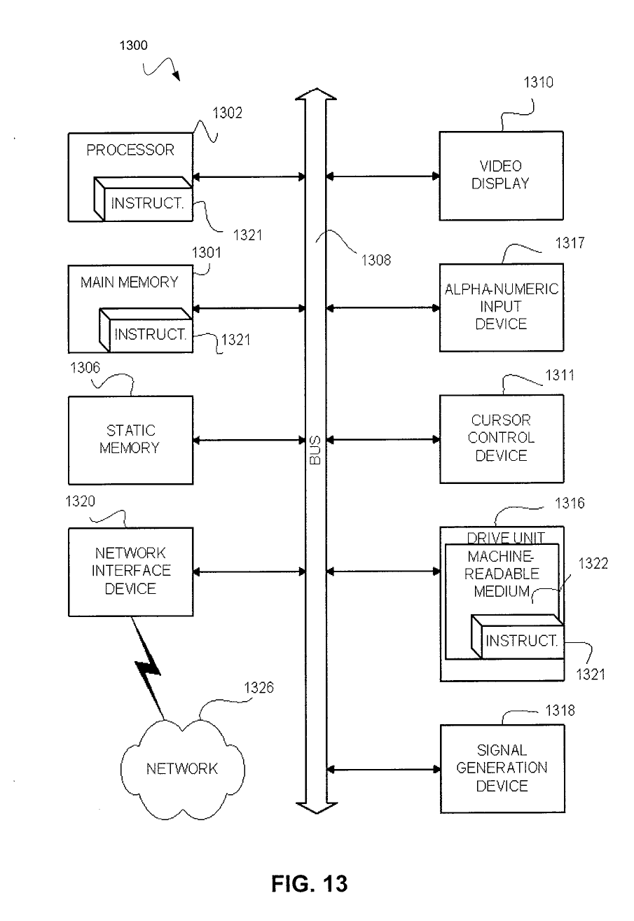

FIG. 13 is a block diagram of machine in the example form of a computer system within which instructions, for causing the machine to perform any one or more of the methodologies discussed herein, may be executed, in accordance with some example embodiments. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1300 includes a processor 1302 (e.g., a central processing unit (CPU), a graphics processing unit (GPU) or both), a main memory 1301 and a static memory 1306, which communicate with each other via a bus 1308. The computer system 1300 may further include a video display unit 1310 (e.g., liquid crystal display (LCD) or a cathode ray tube (CRT)). The computer system 1300 also includes an alphanumeric input device 1317 (e.g., a keyboard), a user interface (UI) navigation device 1311 (e.g., a mouse), a disk drive unit 1316, a signal generation device 1318 (e.g., a speaker) and a network interface device 1320.

### Machine-Readable Medium

The disk drive unit 1316 includes a machine-readable medium 1322 on which is stored one or more sets of instructions and data structures (e.g., software 1321) embodying or utilized by any one or more of the methodologies or functions described herein. The software 1321 may also reside, completely or at least partially, within the main memory 1301 and/or within the processor 1302 during execution thereof by the computer system 1300, the main memory 1301 and the processor 1302 also constituting machine-readable media.

While the machine-readable medium 1322 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

### Transmission Medium

The software 1321 may further be transmitted or received over a communications network 1326 using a transmission medium via the network interface device 1320 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks) The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments illustrated. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
determining, using one or more processors, position information of one or more page items on a page;
determining position information of one or more gaps associated with the one or more page items on the page, each gap defined by respective boundaries of at least two page items;
highlighting the boundaries of a first gap of the one or more gaps based on determining that a cursor controlled by a pointing devices is within the boundaries of the first gap, the highlighting of the boundaries enabling the first gap to be selected and manipulated; and
manipulating, based on the movement of the cursor, the first gap by moving at least one highlighted boundary of the first gap from a first position on the page to a second position. on the page.

2. The method of claim 1, wherein determining the position information of the one or more gaps associated with the one or more page items comprises determining boundaries of the one or more gaps.

3. The method of claim 2, wherein determining the position information of the one or more gaps associated with the one or more page items comprises determining coordinate information of four corners of the first gap based on the boundaries of the one or more gaps.

4. (canceled)

5. The method of claim 1, wherein the at least one highlighted boundary of the first gap is moved vertically, horizontally or both.

6. The method of claim 3, further comprising:
identifying at least one page item associated with the first gap; and
manipulating the at least one page item based on manipulating the position of the first gap.

7. The method of claim 3, wherein the first gap is associated with at least a first page item and a second page item, and wherein manipulating the first gap comprises adjusting positions of the at least first page item and second page item simultaneously.

8. The method of claim 1, further comprising:
manipulating based on position information, a second gap simultaneously with manipulating the first gap based on the position information of the one or more gaps.

9. The method of claim 1, further comprising:
determining position information of a cursor on the page, the cursor associated with a pointing device; and
based on the position information of the cursor being within the one or more gaps, presenting information associated with the one or more gaps,

10. (canceled)

11. The method of claim 9, wherein presenting the information associated with the one or more gaps comprises presenting a list of the one or more gaps,

12. The method of claim 11, wherein the list is presented based on one or more criteria.

13. The method of claim 9, wherein presenting the information associated with the one or more gaps comprises presenting information associated with a smallest gap.

14. The method of claim 1, wherein the page comprises four margins, and wherein the one or more page items on the page comprises only portions of the page items that are within the four margins.

15. The method of claim 14, wherein a boundary of the first gap abuts one edge of a page item or one margin of the page.

16. A computer-implemented method comprising:
presenting a tool to enable manipulating a gap on a page in response to manipulation of a cursor controlled by a pointing device, the gap being adjacent to at least one page item on the page and defined by respective boundaries of at least two page items;
determining position information of the cursor on the page, and based on the position. information of the cursor being within the boundaries of the gap, highlighting the boundaries of the gap to enable the selection and manipulation of the gap using the cursor; and
determining whether adjustment of at least one edge of a page item is necessary based on the gap being manipulated using the tool.

17. The method of claim 16, wherein the gap is adjacent to at least one margin of the page.

18. The method of claim 16, further comprising:
determining position information of the at least one page item.

19. The method of claim 18, further comprising:
updating the position information of the at least one page item based on the adjustment of at least one edge of the page item.

20. The method of claim 18, further comprising:
determining position information of the gap based on the position information of the at least one page item.

21. The method of claim 16, further comprising:
presenting a gap layer tool to enable selecting a gap layer on the page, wherein manipulation of gaps in a first gap layer is independent of manipulation of gaps in a second gap layer.

22. The method of claim 16, further comprising:
displaying attributes of gaps that are associated with a current position of a cursor.

23. The method of claim 16, wherein the tool to enable manipulating the gap on the page is presented in a tool palette associated with a design application.

24. A machine-readable medium having instructions that, when executed by a processor, cause the processor to perform operations comprising:
determining position information of one or more page items on a page;
determining position information of one or more gaps associated with the one or more page items on the page, each gap defined by respective boundaries of at least two page items;
highlighting the boundaries of a particular gap of the one or more gaps based on determining that a cursor controlled by a pointing device is within the boundaries of the particular gap, the highlighting of the boundaries enabling the particular gap to be selected and manipulated;
and presenting information associated with the particular gap.

25. The machine-readable medium of claim 24, further comprising:
determining the position of the cursor; and
determining whether the position of the cursor is within the boundaries of the one or more gaps,

26. (canceled)

27. The machine-readable medium of claim 24, further comprising:
enabling adjusting positions of one or more gaps on the page; and
updating the position information of the one or more page items on the page based on adjusting positions of the one or more gaps on the page.

28. The machine-readable medium of claim 27, further comprising:
presenting a gap tool to enable adjusting the positions of the one or more gaps on the page.

29. A system comprising:
a processor-implemented page item position determination module to determine position information of one or more page items on a page;
a processor-implemented gap position determination module to determine position information of one or more gaps on the page based on the position information of the one or more page items on the page, each gap defined by respective boundaries of at least two page items; and
a processor-implemented gap tool operation module to highlight the boundaries of a particular gap of the one or more gaps based on determining that a cursor controlled. by a pointing device is within the boundaries of the particular gap of the one or more gaps, and to enable manipulation of the highlighted boundaries and to adjust position information of one or more page items affected by the manipulation of the highlighted boundaries.

30. (canceled)

31. The system of claim 29, wherein the position information of the one or more page items and of the gaps on the page includes coordinate information.

32.-33. (canceled)

34. The computer-implemented method of claim 1, further comprising:
detecting a key press of a keyboard during manipulation of the first gap; and
based on the key press, determining whether a page item defining a boundary of the first gap is to be repositioned or resized.

35. The computer-implemented method of claim 1, further comprising:
detecting a key press of a keyboard during manipulation of the first gap; and
based on the key press, determining which page items having boundaries defining the gap are to be repositioned or resized as a result of the manipulation of the first gap.

36. The computer-implemented method of claim 1, wherein one page item defining a boundary of the first gap is an image, the method further comprising:
resizing the page item in response to manipulation of the first gap with the gap tool; and
enabling selection of a portion of the image to be displayed in the resized page item.
